(19) United States
(12) Patent Application Publication
(10) Pub. No.: US 2005/0096102 A1
(43) Pub. Date: May 5, 2005

(54) Remotely initiated low power mode

(75) Inventors: Von A. Mock, Boynton Beach, FL (US); Eric T. Eaton, Lake Worth, FL (US); Fernando L. Guerrero, Plantation, FL (US); David J. Hayes, Lake Worth, FL (US); Joseph Patino, Pembroke Pines, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC, SCHAUMBURG, IL (US)

(21) Appl. No.: 10/701,749

(22) Filed: Nov. 5, 2003

(51) Int. Cl. H04M 1/00; H04B 7/00

(52) U.S. Cl. 455/574; 455/69

(57) ABSTRACT

A method is provided for adjusting power consumption in a device 200. According to the method, a command 400 to enter a low power mode is received, and, in response to receiving the command 400, at least one operating mode of the device 200 is adjusted so as to enter a low power operating mode. In one embodiment, the at least one operating mode that is adjusted includes at least one of a quality of service setting, a vocoding ratio, a BER threshold that initiates background scanning, a frequency of monitoring other communications networks, a definition of a function key, an operating mode of a display, a resolution of a display, a sensor, a CPU clock speed, and an alert time.

### FIELD OF THE INVENTION

The present invention generally relates to the field of wireless communications devices and more particularly to remotely controlling modes of such devices.

### BACKGROUND OF THE INVENTION

Portable electronic communications devices, including bi-directional communications voice and/or data devices such as radios and cellular telephones and receive only devices such as paging devices, are widely used. Among the uses for these devices, they play an important role in supporting providers of emergency services such as fire departments, ambulance services, and other public safety, health and protection providers.

Batteries are typically chosen for use in portable communication devices that have capacities to allow sufficient operation under normal situations. This allows the user to monitor their battery capacity and regulate battery charging and use in a casual manner during normal operations. The user becomes accustomed to their battery life for a typical mode of operation and will charge their battery at correspondingly regular intervals. Operational procedures in public service or commercial environments also often account for anticipated battery life during normal situations and specify suitable recharging schedules. For example, emergency workers might typically recharge their radios after each shift.

During an emergency situation, such as after a terrorist attack, radio and communications network traffic in general, and especially the use of communications devices used by the individuals that are involved in responding to the emergency situation, increases to a level that accelerates the current drain on the battery. This is due to the increased level of talk time, packet data and use of features of the mobile device in communicating during the response to the emergency situation. This increased current drain renders the device unusable in a shorter period of time. A conventional method of addressing this situation is to distribute additional batteries to people who are responding to an emergency situation.

Users of portable communications devices are able to configure characteristics of the device to consume less energy. Examples of characteristics that can be altered to reduce energy consumption include certain convenience features in the device that consume battery life, such as main displays that stay on while the user is talking, color to gray scale display changes, long backlight time-outs, status LED's, fun lights, long alerts, elimination of polyphonic ring tones and so on. Most users in normal circumstances find that the feature brings enough value to warrant the reduced battery life caused by the feature. Users can, however, disable these features in emergency situations to increase their talk time. Unfortunately, reconfiguration of all of the energy saving characteristics of a portable communications device is often a tedious process and a user might not remember all or even most of the characteristics that have to be modified in order to maximize battery life. Also, in emergency situations, the user is too pre-occupied with the emergency to be expected to remember to manage their phone's battery, let alone adjust all of the characteristics that will result in minimizing the device's energy consumption.

In addition, some features are considered basic operational features in normal situations and are considered to provide a minimal quality of service. Users are typically not provided with an ability to modify these features and are thereby not able to provide a greater level of energy conservation.

Therefore, what is needed is a way to ensure that portable communications devices operate in a low power configuration at times when such operation is desired or necessary.

### SUMMARY OF THE INVENTION

According to a preferred embodiment of the present invention, there is provided a method for adjusting power consumption in a device. According to the method, a command to enter a low power mode is received. At least one operating mode of the device is adjusted in response to receiving the command so as to enter a low power operating mode.

In another embodiment of the present invention, there is provided an electronic device that includes a receiver for receiving a command to enter a low power mode, and a mode controller that is communicatively coupled to the receiver. The mode controller adjusts at least one operating mode of the device so as to enter a low power operating mode when the command is received by the receiver.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an exemplary wireless communications network that incorporates embodiments of the present invention.

FIG. 2 is a front view of a cellular phone according to a preferred embodiment of the present invention.

FIG. 3 is a bock diagram for the cellular phone illustrated in FIG. 2 in accordance with a preferred embodiment of the present invention.

FIG. 4 is a data diagram of an alert message according to a preferred embodiment of the present invention.

FIG. 5 is a data diagram of a URL alert message contained within the alert message illustrated in FIG. 4 in accordance with a preferred embodiment of the present invention.

FIG. 6 is a processing flow diagram for entering a user-initiated extended operating mode according to a preferred embodiment of the present invention.

FIG. 7 is a processing flow diagram for entering a system-initiated extended operating mode according to a preferred embodiment of the present invention.

FIG. 8 is a device address comparison processing flow diagram performed within the processing flow illustrated in FIG. 7 according to a preferred embodiment of the present invention.

FIG. 9 is a device location comparison processing flow diagram performed within the processing flow illustrated in FIG. 7 according to a preferred embodiment of the present invention.

FIG. 10 is a battery status reporting processing flow diagram according to a preferred embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The present invention, according to a preferred embodiment, overcomes problems with the prior art by providing a method and apparatus that automatically manages the battery of a portable communications device in emergency situations. Public service users that are called upon to respond to emergency situations generally use these communications devices, although any user of such a portable communications device can benefit from these features.

The exemplary embodiment of the present invention includes: notifying the user that there is an emergency mode situation and included in that notification is a command directing the portable communications device to go into an extended power savings mode. The mobile device modifies its energy management behavior, after an optional approval by the user, to extend its normal operating time by disabling or altering the configuration of features that are not necessary to the operation of the portable communications device. Some embodiments further monitor battery charge status in the portable communications device and transmit a notification to a central controller when the device's battery reserve falls below a threshold, so as to allow the dispatch of a newly charged battery to the user of that device. Additionally, some embodiments support remotely or locally commanding the mobile device to exit its low power mode and return to its normal mode. In the context of the present invention, a “command” can be a set of instructions or a message that prompts an action in accordance with a set of instructions. For example, a command can be included in a message received over a network, or a command can be received from a user of the device (e.g., by pushing one or more buttons).

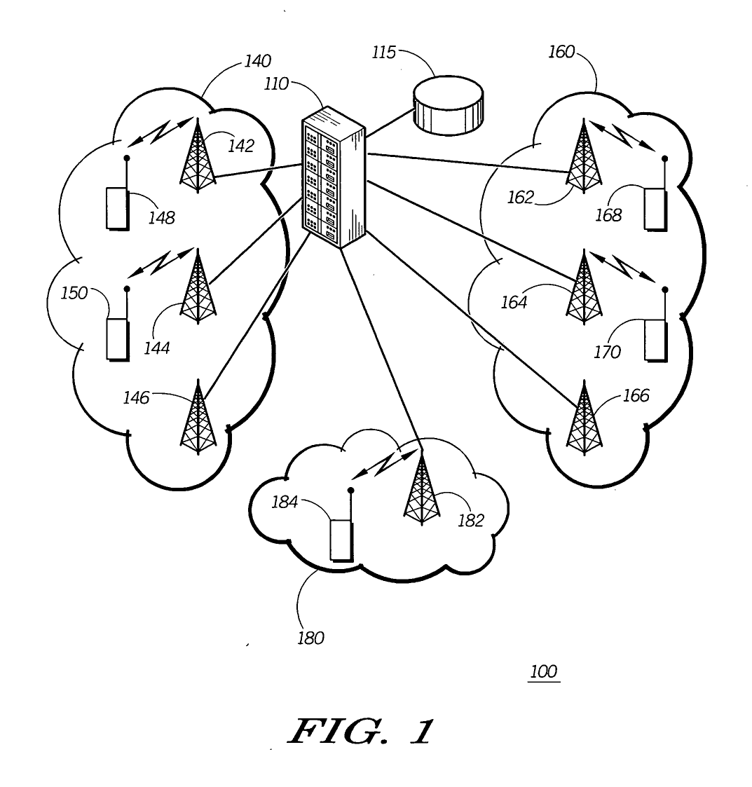

An exemplary wireless communications network 100 that incorporates embodiments of the present invention is illustrated in FIG. 1. The exemplary wireless communications network 100 incorporates a number of service areas, such as Area A 140, Area B 160 and Area C 180. Each area in this exemplary embodiment has at least one wireless communications base station, such as base station A 142, base station B 144 and base station C 146 that are within Area A 140. These base stations are in wireless communications with portable communications devices that are within their associated area and coverage, such as Radio A 148 and Radio B 150 that are shown to be within Area A 140 in this example. The areas are alternatively able to be defined in a number of ways, such as by area code, postal ZIP code, time zone, cellular tower, network identification or by a range of geographical coordinates.

Each base station in this exemplary embodiment is in communications with a central server 110. Central server 110 coordinates operation of the wireless network 100 and the operation of the base stations. Central server 110 also controls the transmission of user data and voice information from portable communications devices that use the wireless network. Central server 110 in the exemplary embodiment further coordinates the communications of control and status messages to the portable communications devices that use the wireless communications network 100, such as the alert messages used as reconfiguration command messages that are described below. Server 110 also maintains a record alert database 115 that stores data relevant to the transmission of alert messages.

The wireless communications network 100 can be configured to periodically transmit data messages, which are referred to as cell broadcasts, that are addressed to specified portable communications devices. These data messages have an addressee identification to specify which portable communications device or devices are to receive and process the data message. The portable communications devices are able to be configured with one or more identifiers that correspond to the addressee identification within the data messages transmitted within the wireless communications network. When a portable communications device receives a data message that has an addressee identification that corresponds to an identifier that is associated with the device, that message is decoded and processed by the device. The central server 110 of the wireless communications network 100 can be configured to periodically transmit cell broadcasts on a pre-defined schedule. This feature is used by the exemplary embodiment of the present invention as is described below.

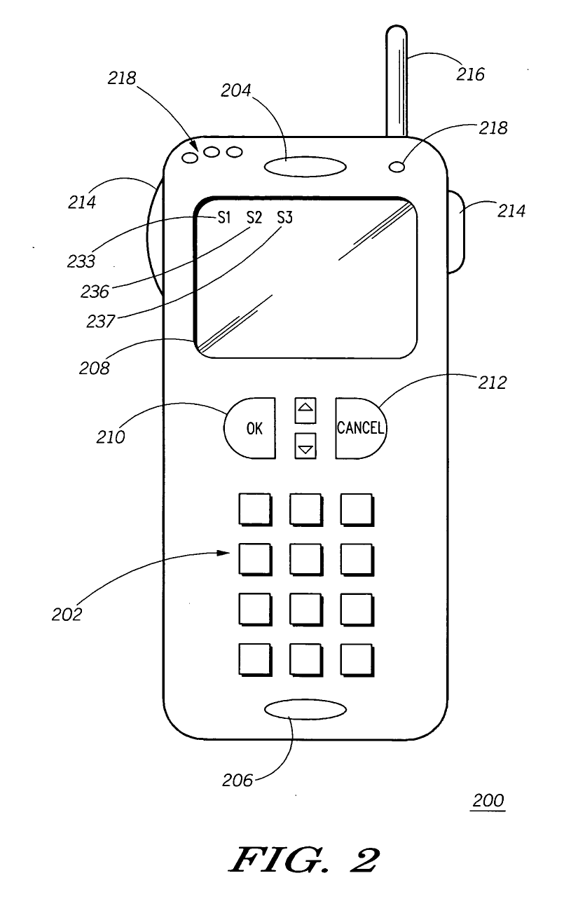

A front view of a cellular phone 200 that is used as a portable communications device within an exemplary embodiment of the present invention is illustrated in FIG. 2. The cellular phone 200 has an outward appearance that is similar to conventional cellular phones. The cellular phone 200 has a display 208 that allows alphanumeric and graphical information to be presented to a user. The display 208 of this exemplary embodiment contains three indicators: an S1 indicator 233, an S2 indicator 236 and an S3 indicator 237. The S1 indicator 233 indicates the existence of an emergency or abnormal situation as is determined by data received by the cellular phone over the communications network. The S2 indicator 236 indicates if the user of the cellular phone has selected a low power mode for the cellular phone. The S3 indicator 237 indicates that a low battery energy transmission has been transmitted to a central controller and an acknowledgement has been received, and can also include an estimated time at which a replacement battery will be delivered to the user.

The cellular phone 200 also has a conventional cellular phone keypad 202 that includes an “OK” button 210 and a “CANCEL” button 212 that allow the user to respond to prompts or questions presented on display 208. These buttons can be “hard” buttons that perform fixed functions, or “soft” buttons that perform different functions at different times. The cellular phone 200 includes a speaker 204 and a microphone 206 to support voice communications.

Cellular phone 200 has an external RF antenna 216 to support radio connectivity with the base stations of the radio network in which the cellular phone operates. Cellular phone 200 has status LEDs 218 to provide the user with indications of certain operating modes, such as transmitting or out of radio coverage. The cellular phone 200 further has “fun lights” 214 that illuminate when an incoming call is received or in response to other events.

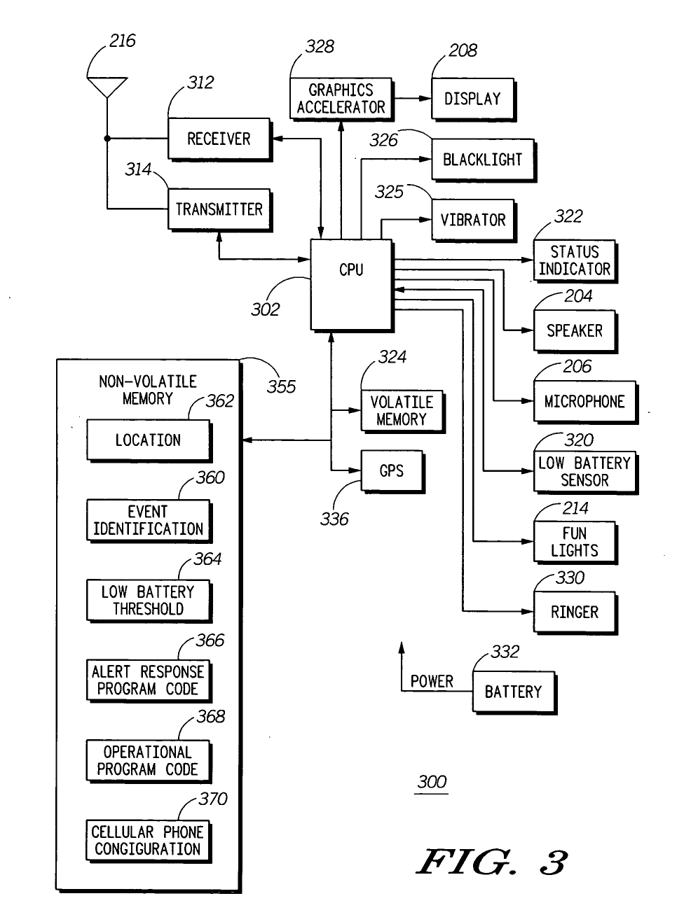

A block diagram of a cellular phone according to an exemplary embodiment of the present invention is illustrated in FIG. 3. The cellular phone 300 includes a CPU 302 that controls the operation of the cellular phone and all of the devices therein. Embodiments of the present invention include CPU 302 that includes of one or more specialized digital signal processors (DSPs) that perform specialized signal processing according to the requirements of the cellular phone. The CPU 302 of the exemplary embodiment performs the functions of a mode controller to adjust the operating modes of the cellular phone 300.

The cellular phone 300 of the exemplary embodiment has a transmitter 314 and a receiver 312 that are used for bi-directional voice and data communications through the antenna 216. The exemplary embodiment of the present invention communicates voice information that has been digitized so that all communications performed by the receiver 312 and transmitter 314 are digital in nature. Embodiments of the present invention operate by using analog voice modulation techniques to communicate voice signals. Data produced by the receiver 312 is processed and decoded by CPU 302 in the exemplary embodiment. Decoding of data by the CPU 302 is included in the receiver functions in the exemplary embodiment of the present invention.

The cellular phone 300 of the exemplary embodiment includes a GPS receiver 336. The GPS receiver 336 is used to determine the location of the cellular phone. The location of the cellular phone is used in a variety of ways, including the selective transmission of the currently determined location to a central server 110.

The cellular phone 300 includes a non-volatile memory 355. The non-volatile memory 355 of the exemplary embodiment is a low power memory that has a battery power back-up to ensure that data is retained. The non-volatile memory 355 of the exemplary embodiment includes an event identification 360, which is an identification number or address that is programmed into the cellular phone to allow emergency alert messages, or messages associated with other events, to be specifically addressed to this cellular phone. Embodiments of the present invention can store more than one event identification 360 value in the non-volatile memory 355. These multiple event identification 360 values allow the device to respond to more than one addressee identification that is specified in an alert message, as is described below. The event identification 360 in the exemplary embodiment is frequently used as a group address in that multiple devices are typically configured with the same event identification 360 value and all of these devices will process alert messages 400 that are addressed to that value.

The non-volatile memory 355 further includes a location data element 362. The location data element 362 in the exemplary embodiment is a location description for the portable communications device that is periodically updated with the current location of the device. The exemplary embodiment updates this location information with data determined by the GPS receiver 336. Some embodiments of the present invention receive alternative location data from a central server 110. This alternative location data is able to be in the form of a ZIP-code, telephone area code, time zone, or other geographical descriptor. The alternative location data that is to be stored in location 362 is able to be determined by an association with the communications tower with which the portable communications device is communicating, through GPS data or through any other known means. Some embodiments of the present invention transmit geographical location information that was derived by the GPS receiver 336 to the central server 110, and the central server 110 returns the location data that is to be used by the portable electronic device, such as a ZIP-code, area code, time zone, network identification representing a geographic area or other descriptor. This alternative location information is used in embodiments that address alert messages to portable electronic devices based upon the device's location, as is described below.

The non-volatile memory 355 also stores a low battery threshold 364. The value of the low battery threshold 364 is used to determine when the battery 332 requires recharging or replacing, as is described below. The operation of the portable communications device 200 periodically compares a measured battery energy level to the low battery threshold 364 to determine acceptable battery energy level and to notify a central server 110 of a need for a replacement battery.

The non-volatile memory 355 further includes the program code that is executed by the CPU 302. The non-volatile memory 355 contains an alert response program code module 366 that controls the processing to implement the alert response processing as is described below. The non-volatile memory 355 further contains an operational program code module 368 that controls the processing performed by the CPU 302 to implement conventional cellular phone operations.

Non-volatile memory 355 includes cellular phone configuration data 370. The cellular phone configuration data 370 includes configuration data such as incoming call notification configurations, e.g., ringer volume, vibration on/off, and fun lights activation. The cellular phone configuration data 370 further includes data such as backlight time out and backlight intensity. The cellular phone configuration data 370 further includes other configuration data for the cellular phone 200, including configuration data modified by the alert message processing as is described below.

The cellular phone 300 includes a volatile memory 324. The volatile memory 324 is used to store transient data used by CPU 302. The volatile memory 324 is able to store, for example, data that is used or displayed to the user. The volatile memory 324 is able to be located wholly within the cellular phone. The cellular phone further allows the addition of external volatile memory devices to expand the available volatile memory of the cellular phone.

The cellular phone 300 includes a graphics accelerator 328 that receives display information from CPU 302 and drives display 208 with alphanumeric and graphical data to display to the user. The display 208 has a backlight 326 that provides illumination of the display to allow easy reading in dim and dark ambient environments.

The cellular phone 300 includes a vibrator 325 and a ringer 330 to provide the user with a notification of an incoming call, message or other event. The CPU 302 controls the vibrator 325 and ringer 330 in the exemplary embodiment. The cellular phone 300 of the exemplary embodiment also includes “fun lights” 214 that are illuminated and flashed to notify the user in response to various events. The fun lights 214 of the exemplary embodiment are controlled by CPU 302. Fun lights 214 and vibrator 325 generally consume excess electrical energy and are typically disabled in low power operating modes. Low power operating modes of the exemplary embodiments use ringer 330 to provide an indication of an incoming call as ringer 330 of the exemplary embodiment uses less energy than vibrator 325 and fun lights 214. In addition, basic ringer alerts override higher power consuming polyphonic ring tones and other polyphonic alerts. Low power operating modes of the exemplary embodiment further include reducing display backlight timeouts. The speaker 204 and microphone 206 are controlled and monitored, respectively, by the CPU 302 which provides the necessary analog to digital conversions required to interface these analog devices to the digital processing performed by circuits within CPU 302.

Embodiments of the present invention adjust at least one of a large number of operational settings in order to reduce energy consumption. Examples of operational settings adjustments in various embodiments include, but are not limited to, the following:
1) adjusting the quality of service settings, such as allowable Bit Error Rate (BER), to the most power efficient available to the device that will continue to support acceptable message exchange (For example, adjustment of the Vocoding ratio to 6:1 instead of the standard 3:1);
2) relaxing the BER threshold that initiates background scanning so that scanning through neighboring cell lists is reduced or stopped (For example, the threshold for scanning or switching to an 802.11 standard network or to a cellular network can be relaxed);
3) selecting a primary communication system and either turning off or reducing the frequency in which the other communication networks are monitored (For example, if a simplex system is chosen as the primary network, scanning for cellular, 802.11 and Bluetooth networks is reduced. The selection of the primary network is able to be performed by the central server 110 based on traffic and known power consumption. This selection is also able to be addressed to groups or individuals devices.);
4) reconfiguring function keys so as to continue operation in the primary communications mode (For example, if a duplex mode is chosen as a primary communications mode, a Push To Talk (PTT) button on the device is configured to cause a duplex call to be made instead of initiating a simplex call.);
5) providing a “Homeland Security Mode” until the user confirms operation in the remote initiation mode;
6) alteration of the operating mode based upon the needs of a user (For example, devices for people with hearing impairments do not completely disable the display);
7) configuring the display to black and white or a lower resolution if the display is to be used in the selected mode;
8) turning off unnecessary sensors, such as motion and temperature sensors;
9) configuring the CPU to operate with a slower clock and/or at its lowest operating voltage given operational requirements; and
10) delaying reminder alerts until the device returns to normal operating mode.

The cellular phone 300 includes a battery 332 to provide power to the circuits of the cellular telephone 200. The cellular phone 300 of the exemplary embodiment further includes a low battery sensor 320 which is a battery monitor that determines when the energy level of the battery 332 falls below the pre-programmed level defined by the low battery threshold 364.

A data diagram of an alert message 400 as is used by an exemplary embodiment of the present invention is illustrated in FIG. 4. The alert message 400 is a data message that is periodically transmitted by the wireless communications network 100 of the exemplary embodiment. The exemplary embodiment is configured to transmit cell broadcast messages at a pre-defined schedule and the portable communications devices are similarly configured to monitor for the cell broadcast according to this pre-defined schedule.

The alert message 400 conveys a command to enter a low power mode and contains fields identified such as the ALERT_ID 410, MSN 415, EOA 420 and ALERT_INFORMATION 425. The ALERT_ID field 410 in this exemplary embodiment is an addressee identification of part of the cell broadcast occurring within a given cell. Portable communications devices 200 in this embodiment are programmed with one or more event identification 360 values that are used to address alert messages 400 to selected portable communication devices 200. The portable communications devices, such as cellular phone 200 of the exemplary embodiment, monitor alert messages 400 and if the ALERT_ID 410 matches at least one event identification 360 value that is programmed into the device, the device responds as described below. The device will generally go into an extended low power mode of operation when an ALERT_ID 410 that matches the event identification 360 is decoded within a cell broadcast.

As an alternative to broadcasting ALERT_ID information 410 that is intended to match the event identification 360 that is configured within the portable wireless device, the ALERT_ID field is able to contain location information that defines a zone in which portable communication devices 200 are to respond to the alert notification message 400. In this alternative, the ALERT_ID 410 contains a zone descriptor, such as a network identification, tower identification, ZIP code, an area code, a time zone or a geographic coordinate range to which the device location 362 is compared. Some embodiments include a flag within the alert ID 410 to distinguish between these two addressing modes.

The alert notification message 400 contains a Message Sequence Number (MSN) 415 that identifies the alert notification message 400. Alert notification messages 400 in the exemplary embodiment are periodically retransmitted according to a pre-defined schedule in order to ensure their receipt by portable communication devices 200 that are temporarily unable to receive a message. If no new alert information is to be transmitted, the previous message is retransmitted with the same MSN 415. When an alert message 400 with new information is to be transmitted, it is assigned an MSN 415 that is different than the previously used MSN 415 value. In the exemplary embodiment, the MSN 415 consists of two bits that are used to count from 0 to 3. The portable communication device 200 receiving the alert notification message 400 will continue to decode the remainder of the alert notification message, including the ALERT_INFORMATION field 425 described below, if the MSN value 415 has changed from the alert notification message that has been previously processed. The MSN value 415 is put near the front of the message, right after the ALERT_ID field 410, to allow the mobile device to identify if continued processing is required. If the MSN value 415 has not changed since the last decoded alert notification message 400, the processing of the received data, including the powering of the receiver 312, shuts down immediately after decoding the MSN 415 so as to conserve energy.

The alert notification message 400 of the exemplary embodiment also includes an End Of Alert (EOA) flag 420. The EOA flag of the exemplary embodiment is assigned a value of TRUE or FALSE. A value of TRUE indicates that the Alert situation that was notified to the portable communications device 200 by a previous alert message 400 has ended and the portable communication device 200 can return to normal operation. A value of FALSE indicates that the alert situation is continuing and that the portable communication device 200 is to remain in a low power mode of operation.

The ALERT_INFORMATION field 425 contains an arbitrary number of bytes according to the information being transmitted. In the exemplary embodiment, alert messages 400 are sent over the wireless communications network 100 so that all of the portable devices operating can decode and receive the information at one time. The ALERT_INFORMATION Field 425 is able to contain variable length text messages that include an indication of how many octets are contained within this message, so as to indicate the length of the message. Embodiments of the present invention alternatively transmit a standard length message that contains a minimal amount of information and may also includes a Uniform Resource Locator (URL) that indicates a location containing additional information that can be retrieved by a device. The URL can include a short code consisting of a minimal set of numeric and alpha characters as well as user friendly descriptive strings.

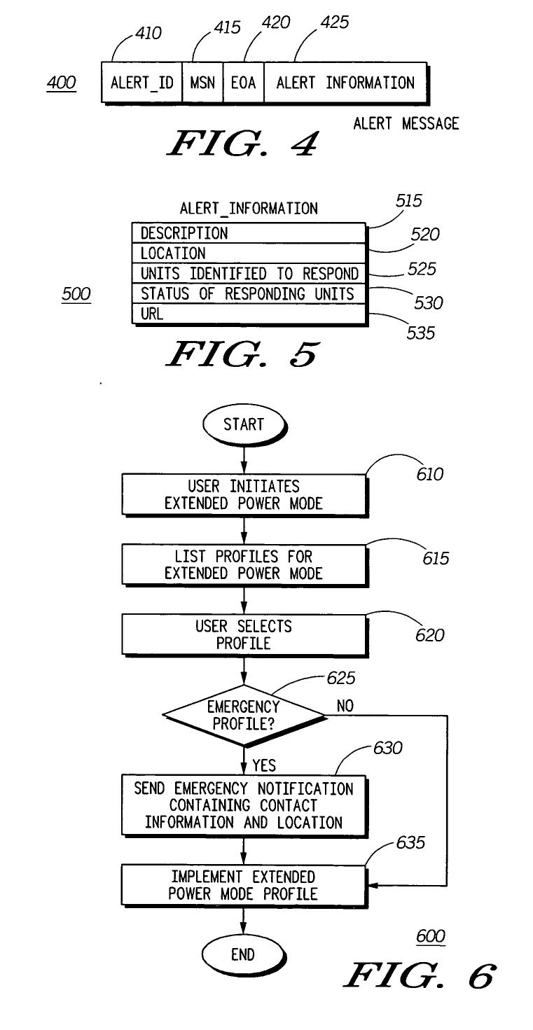

A data diagram of a URL alert message 500 as is used by embodiments of the present invention is illustrated in FIG. 5. The URL alert message 500 is included in the alert information field 425 of the alert message 400. The URL alert message 500 contains a description field 515 that is transmitted in a format understandable to the person reading it, e.g., a alphanumeric ASCII string indicating “Dirty Bomb Explosion—All Emergency Personnel Need to Respond.” This information is typically brief since further information is available at the URL 535, as discussed below.

The URL alert message 500 also contains a location field 520 that provides a geographical specification of the location of the incident. The location field 520 is able to contain a single geographical point coordinates for a bomb explosion, or the location field 520 is able to contain one or more counties, area codes, tower identifications, network identifications, and/or ZIP codes for alerts related to such things as weather events, e.g., a hurricane or tornado.

The URL alert message 500 also contains a list of units identified to respond 525. The list of units identified to respond 525 lists the units or personnel that are to respond to the alert along with possible contact information. An example of the data contained in units identified to respond 525 is an alphanumeric ASCII data string containing “Fire units 213 and 345, Police units 789 & 538 (123)-555-1212, Medical units 23 & 703.”

The URL alert message 500 further contains a status of responding units 530. The status of responding units 530 lists the units that have responded along with each unit's current status, e.g. an alphanumeric ASCII string containing “Medical Unit 23 en route, Medical Unit 703 at scene, Fire unit 213 delayed, Fire unit 345 en route—5 mins estimated time of arrival, Police units 789 & 538 at scene.”

The URL alert message 500 also contains a URL specification 535. The URL specification 535 includes a specification of a Universal Resource Locator (URL) from which a portable communications device 200 can retrieve further information about the alert that is the subject of the alert message 400. Preferred embodiments of the present invention transmit messages that have only the URL specification 535 and other minimal information, so that a user who desires to learn more about the alert can retrieve and be presented with the further information by accessing the URL specified in the URL specification 535.

A processing flow diagram for entering a user-initiated extended operating mode 600 as is used by an exemplary embodiment of the present invention is illustrated in FIG. 6. The exemplary embodiment of the present invention allows a user to initiate the change of the operating mode of the portable electronic device into an extended operating, i.e., low power, mode. The user performs this processing, for example, when the user has an abnormal or emergency situation that requires an extended power mode. As a specific example, the user may be on a kayak in the ocean that has been taken farther out into the ocean and the user cannot get back to shore because of adverse ocean currents. In this exemplary case, the user initiates, at step 610, the extended power mode. The device prompts, at step 615, the user with a list of profiles that are stored in the device. These profiles are stored in the device by being previously configured by the user, installed at the factory or by being previously received through over the air programming. The user selects, at step 620, the most appropriate profile. In this example, the user selects the highest priority extended power profile. The highest priority extended power profile in this example is defined as the “emergency profile” and results in maximum power savings. The processing then determines, at step 625, if the user has selected the emergency profile. If it is determined that the user selected the emergency profile, the processing sends, at step 630, to a central server 115 or other location, a notification that contains user identification, contact information and the current location of the portable device. Once the transmission of the emergency notification is completed or if the user selected another low power non-emergency profile, the mobile processing device then implements, at step 635, the selected extended power mode profile.

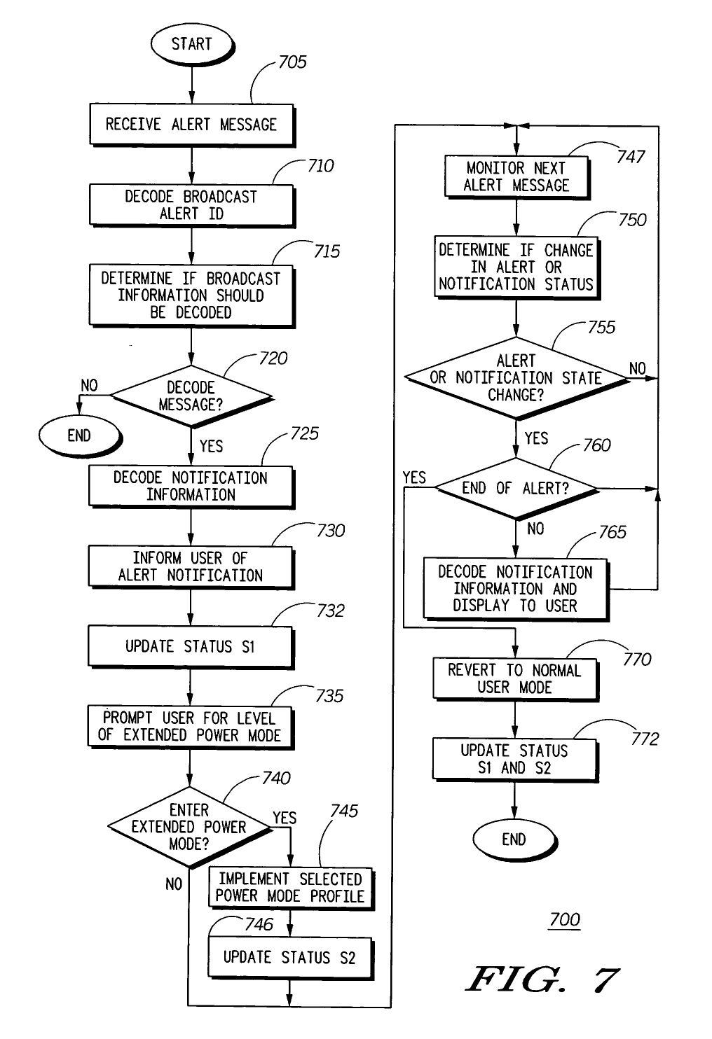

A processing flow diagram for entering a system-initiated extended operating mode 700 as is used by an exemplary embodiment of the present invention is illustrated in FIG. 7. The system-initiated extended operating mode 700 provides a system initiated method for a mobile device to be directed to go into a extended power savings mode in response to, for example, an abnormal or emergency situation.

The processing for entering a system-initiated extended operating mode 700 begins by receiving, at step 705, an alert message 400 at the portable communication device 200. The processing continues by decoding, at step 710, the broadcast ALERT_ID field 410 that is contained within the received alert message 400. The processing then determines, at step 715, if the broadcast information should be decoded. A broadcast should be decoded, for example, if the value in the ALERT_ID field 410 matches the event identification 360 that was programmed in the portable electronic device. Embodiments that transmit geographic location descriptors within the ALERT_ID field 410 determine the geographic location of the portable communication device 200 and compare this current location to the geographic location descriptor that was included in the ALERT_ID field 410. Further processing to determine if the message is to be decoded includes determining if the MSN field 415 contains a different sequence number than the alert message 400 that was previously decoded. If it is determined that there is no match for the conditions to decode the message, the processing for this message then terminates. The processing of alert messages will resume when the next alert message is expected according to the pre-defined transmission schedule for cell broadcasts used by the exemplary embodiment of the present invention.

If it is determined that there is a match for the conditions to decode the alert message 400, the processing continues by decoding, at step 725, the alert message 400 to determine the value of the data flag EOA 420 and the ALERT_INFORMATION 425 data. The processing then presents, at step 730, the user with an indication of the alert notification, which includes the data contained within the ALERT_INFORMATION field 425. The status indicator S1 233 is updated on the display to indicate to the user that an emergency situation exists. The processing then prompts, at step 735, the user to specify the level of extended power mode into which the portable communication device 200 is to be placed. The user then selects the desired profile level of extended power mode.

The processing next determines, at step 740, if the user has selected to enter an extended power mode, which is an operating mode that conserves electrical power. If the user did select an extended power mode, the processing implements, at step 745, the selected power profile and, at step 746, the status indicator S2 236 is updated to show the user that the device is in an extended power operation mode.

Some embodiments of the present invention do not present a selection of profiles to the user and simply place the device into a pre-defined, low-power state. Other embodiments have only one low power profile and simply prompt the user whether or not to enter this low power state.

The processing then continues by monitoring, at step 747, for alert messages 400 at the appropriate times on the cell broadcast channel according to the pre-defined transmission schedule used by the exemplary embodiment. The processing then determines, at step 750, if a change in status is indicated in this newly received alert message 400. The determining of a change of status in the exemplary embodiment is determined by a change in the contents of one or more of the MSN field 415 or the EOA field 420. Some embodiments of the present invention use other data within the alert message 400 to determine if there has been a change in alert or notification status. The processing next determines, at step 755, if there has been a change in alert or notification state. If a change in alert or notification state is not determined to have occurred, the processing returns to monitoring, at step 747, for the next alert message. If it was determined that there has been a notification state change, the processing next determines, at step 760, if the end of alert (EOA) field 420 of the alert message 400 indicates that the alert has ended. If it is determined that the alert has ended, the processing exits the extended mode of operation and reverts, at step 770, back to the normal mode of operation. After returning to the normal mode of operation, processing for this message terminates and the status indicators S1 233 and S2 236 no longer indicate the existence of an emergency or abnormal event or that the device is in a low power mode of operation. If it is determined that an end of the alert is not indicated, e.g. the change of alert is due to a change in status indicated by a change in MSN 415, the information associated with this alert message 400 is displayed, at step 765, to the user. The processing then returns to monitoring, at step 747, for the next appropriate time to decode an alert notification.

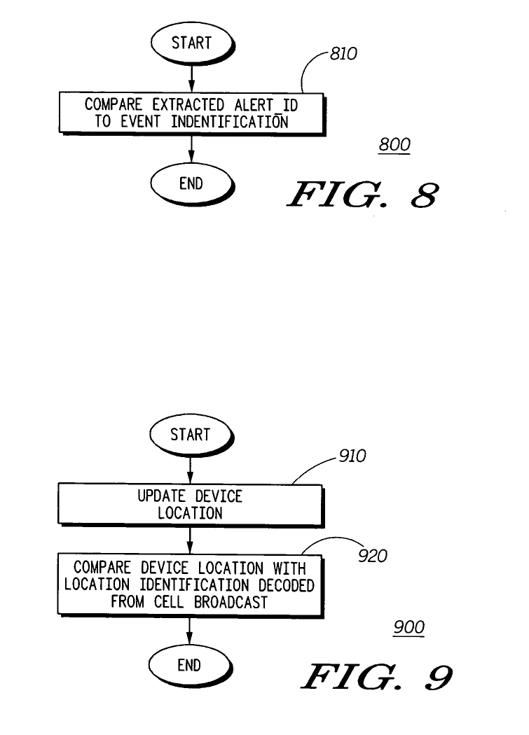

A device address comparison processing flow diagram 800 as is performed by an exemplary embodiment of the present invention is illustrated in FIG. 8. The device address comparison processing implements the determine if broadcast information should be decoded 715 processing step that is part of the processing for entering a system-initiated extended operating mode 700.

The portable communication device 200 of the exemplary embodiment normally decodes cell broadcasts and decodes the information in the alert message once a match is found between the ALERT_ID 410 value and an identifier assigned to the device, such as the event identification 360. Embodiments of the present invention allow more than one event identifier 360 to be assigned to the device and to be stored in non-volatile memory 355. This allows a single portable communication device 200 to respond to alert messages 400 that have different values in the ALERT_ID field 410, so as to allow the portable communication device 200 to be placed in an extended power savings mode in response to alert messages that are directed to different groups.

The device address comparison processing compares, at step 810, the extracted ALERT_ID value 410 to all of the event identifiers 360 that are associated with that portable communication device 200. The results of this comparison are returned to the processing for entering a system-initiated extended operating mode 700 and the processing for the device address comparison processing flow 800 terminates.

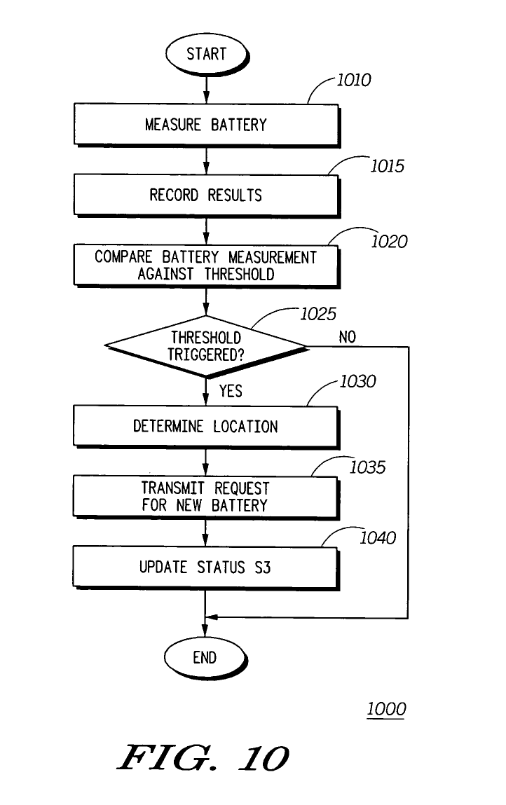

A device location comparison processing flow diagram 900 as is performed by an alternative embodiment of the present invention is illustrated in FIG. 9. The device location comparison processing flow diagram 900 provides an alternate means to address alert messages to portable communication devices 200. The device address comparison processing implements, in this alternative embodiment, the determine if broadcast information should be decoded 715 processing step that is part of the processing for entering a system-initiated extended operating mode 700.

The device location comparison processing flow 900 begins by determining, at step 910, the location of the portable communication device by utilizing the GPS receiver 336. This embodiment of the present invention stores the latitude and longitude information produced by the GPS receiver 336 into the location element 362 of non-volatile memory 355. The determined latitude and longitude is used in a query to a remote site, such as the server 110, for location information that is to be stored in the location element 362 in the internal memory 355. This alternative location information can be stored in addition to or in place of the latitude and longitude produced by the GPS receiver 336. It can be appreciated that the location information is able to be one of an area code, a zip code, a tower identification for the cell tower with which the device is communicating, a network identification for the network over which the device is communicating or a time zone. As an alternative to querying the remote site, the tower identification, network identification, area code, zip code or time zone are able to be transmitted over the air as part of yet another part of an information stream in a cellular broadcast. This cellular broadcast is transmitted to all devices that are communicating via the wireless communications network 100 and indicates to all of these receiving devices the location information that is to be stored in the location element 362 of the internal memory 355. Such embodiments store one or more location elements 362 in the internal memory 355 and a match between any of the location elements 362 and the location specified in the ALERT_ID 410 results in a match and indicate that the associated alert message 400 should be decoded.

The processing then proceeds by comparing, at step 920, the data in all of the location elements 362 that are stored in non-volatile memory 355 to the cellular broadcast decoded ALERT_ID 410. The result of this comparison is returned to the processing for entering a system-initiated extended operating mode 700 and the processing for the device location comparison processing flow 900 terminates. While features of the present invention have been described above with respect to an exemplary communications system and device, the present is not limited to the system and device described above, but can be practiced in any other suitable system or device.

A battery status reporting processing flow diagram 1000 as is performed by an exemplary embodiment of the present invention is illustrated in FIG. 10. The battery status reporting processing 1000 is periodically performed by the exemplary embodiment of the present invention when operating in an extended power savings mode to notify a central controlling location, such as server 110, of the battery charge level for the portable communication devices 200. The operation of the battery status processing 1000 facilitates the dispatch of replacement batteries to users with portable communication devices 200 that have batteries with low energy levels.

The battery status reporting processing flow 1000 begins by measuring, at step 1010, the energy level of the battery 332. The exemplary embodiment uses conventional means to measure the energy level of a battery, such as measuring output voltage and comparing the output voltage to the charge level characteristics of the battery type being used by the portable communications device 200. Preferred embodiments of the present invention extrapolate the remaining amount of usable usage time for the battery 332 based on the rate of power usage over time in light of any software applications that are currently executing on the portable communications device 200. This provides a current snapshot of the energy level of the battery 332.

The battery status reporting processing flow 1000 processing continues by recording, at step 1015, the measured battery energy and the time at which the measurement was taken. The processing then proceeds by comparing, at step 1020, the measured energy level of the battery 332 to the low battery threshold 364 that is stored in the non-volatile memory 355. This comparison depends upon the type of energy measurement that is performed and/or calculated. For example, the threshold is able to use a comparison based upon an extrapolated amount of usable time remaining as the threshold point, e.g. 1 hour of use left. Another example will directly compare the energy level to a threshold, such as ⅓ of total capacity remaining is used as the threshold.

The processing then determines, at step 1025, if the threshold has been triggered. If the threshold is determined to not have been triggered, the processing for this iteration stops. If the threshold is determined to be triggered, the processing continues by determining, at step 1030, the current location of the portable communications device 200. The exemplary embodiment determines the current location by the use of GPS receiver 336. The processing then continues by transmitting, at step 1035, a request for a new battery. If an acknowledgement is received from the server 110, the status S3 indicator 237 is updated. Some embodiments of the present invention include an indication of an estimated time to deliver the additional batteries in the acknowledgement response. The exemplary embodiment transmits this request to a central controller, such as server 110. This information aids the central controller in dispatching replacement batteries to the user of the portable communication device 200 when the battery 332 is becoming depleted.

It can be appreciated that an upward adjustment of the low battery threshold level can be used to result in an earlier transmission of a request for a new battery. This can accommodate longer times to deliver the replacement batteries.

A conventional portable communications device, such as a cellular phone, periodically monitors its battery level to ensure that the device is operating within a normal operating range. A normal operating range is influenced, for example, by the fact that transmit and receive frequencies drift when the voltage applied to the receive circuitry goes below a certain threshold value. Cellular devices are sometimes programmed with the low battery threshold and a second threshold, referred to as a normal operating threshold, where the normal operating threshold is configured to trigger at a higher battery energy, level. The normal operating threshold triggers at a higher battery energy level than is absolutely necessary for any operations so as to ensure that the receiver circuitry is powered by a voltage level that keeps the frequency drift of the RF circuits to within desired levels. During normal operation, the phone will cease to operate once the normal operating threshold has been triggered. However, in the low energy operating mode, preferred embodiments of the present invention are configured to not respond to the normal operating threshold and continue to transmit and receive until the battery has been completely exhausted. In these instances, the low battery threshold is only used to trigger the transmission of a request for a replacement battery. This allows extended operation during these emergency situations.

Some embodiments of the present invention support configuring of the mobile device so as to prevent a user from disabling the energy conservation operating configurations that are configured for the remotely initiated low power mode. This configuration is able to be triggered by one or more parameters received in the message initiating the low power mode, or this configuration can be programmed into the device.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language).

The present invention can be realized in hardware, software, or a combination of hardware and software. A system according to an exemplary embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

1. A method for adjusting power consumption in a device, the method comprising the steps of:
receiving a command to enter a low power mode; and
adjusting, in response to receiving the command, at least one operating mode of the device so as to enter a low power operating mode.

2. The method according to claim 1, wherein in the adjusting step, the at least one operating mode includes at least one of a quality of service setting, a vocoding ratio, a BER threshold that initiates background scanning, a frequency of monitoring other communications networks, a definition of a function key, an operating mode of a display, a resolution of a display, a sensor, a CPU clock speed, and an alert time.

3. The method according to claim 1, further comprising the steps of:
receiving a second command to exit the low power mode; and
adjusting, in response to receiving the second command, the at least one operating mode of the device so as to exit the low power operating mode.

4. The method according to claim 1, further comprising the step of preventing a user from changing the at least one operating mode while the device is in the low power operating mode.

5. The method according to claim 1, further comprising the step of providing at least one status indicator for indicating at least one of an emergency situation and that the device is operating in the low power operation mode.

6. The method according to claim 1,
wherein the command includes a uniform resource locator, and
the method further comprises the step of presenting information associated with the uniform resource locator.

7. The method according to claim 1, wherein the adjusting step comprises:
presenting a user with a plurality of operating modes;
accepting an input from the user that indicates a selected operating mode that is chosen from the plurality of operating modes; and
placing the device into the selected operating mode.

8. The method according to claim 1, further comprising the step of continuing to operate the device after a battery energy level has fallen below a normal operating threshold.

9. The method according to claim 1, further comprising the steps of:
monitoring an energy level of a battery;
comparing the energy level to a threshold;
transmitting an indication of the energy level to a central controller; and
providing an indication that the indication of the energy level has been transmitted.

10. The method according to claim 1, further comprising the steps of:
monitoring an energy level of a battery;
comparing the energy level to a threshold;
transmitting an indication of the energy level to a central controller; and
providing an indication of an estimated time of arrival of a replacement battery.

11. The method according to claim 1, further comprising the steps of:
monitoring an energy level of a battery;
comparing the energy level to a threshold;
transmitting an indication of the energy level to a central controller; and
transmitting a second indication upon replacement of the battery.

12. The method according to claim 1, wherein the command to enter the low power mode is initiated by a user of the device.

13. The method according to claim 1,
wherein the command includes a receiver identification, and
the method further comprises the step of determining if the receiver identification matches an identification associated with the device.

14. The method according to claim 13,
wherein the receiver identification comprises a location description, and
the determining step comprises comparing the location description to a current location of the device.

15. An electronic device comprising:
a receiver for receiving a command to enter a low power mode; and
a mode controller communicatively coupled to the receiver, the mode controller being capable of adjusting at least one operating mode of the device so as to enter a low power operating mode when the command is received by the receiver.

16. The electronic device according to claim 15, wherein the at least one operating mode includes at least one of a quality of service setting, a vocoding ratio, a BER threshold that initiates background scanning, a frequency of monitoring other communications networks, a definition of a function key, an operating mode of a display, a resolution of a display, a sensor, a CPU clock speed, and an alert time.

17. The electronic device according to claim 15,
wherein the receiver is further able to receive a second command to exit the low power mode, and
the mode controller is capable of adjusting the at least one operating mode of the device so as to exit the low power operating mode when the second command is received by the receiver.

18. The electronic device according to claim 15, wherein the mode controller prevents a user from changing the at least one operating mode while the device is in the low power operating mode.

19. The electronic device according to claim 15, further comprising at least one status indicator for indicating at least one of an emergency situation and that the device is operating in the low power operation mode.

20. The electronic device according to claim 15,
wherein the command includes a uniform resource locator, and
the electronic device further comprises a display for presenting information associated with the uniform resource locator.

21. The electronic device according to claim 15, wherein the mode controller is capable of:
presenting a user with a plurality of operating modes;
accepting an input from the user that indicates a selected operating mode that is chosen from the plurality of operating modes; and
placing the device into the selected operating mode.

22. The electronic device according to claim 15, further comprising:
means for monitoring an energy level of a battery, comparing the energy level to a threshold, and transmitting an indication of the energy level to a central controller; and
an indicator for indicating an estimated time of arrival of a replacement battery.

23. The electronic device according to claim 15, further comprising means for monitoring an energy level of a battery, comparing the energy level to a threshold, transmitting an indication of the energy level to a central controller, and transmitting a second indication upon replacement of the battery.

24. The electronic device according to claim 15, wherein in the low power operating mode, the electronic device continues to operate after a battery energy level has fallen below a normal operating threshold.

25. The electronic device according to claim 15, wherein the command to enter the low power mode is initiated by a user of the device.

26. The electronic device according to claim 15,
wherein the command includes a receiver identification, and
the mode controller determines if the receiver identification matches an identification associated with the device.

27. The electronic device according to claim 26,
wherein the receiver identification comprises a location description, and
the mode controller compares the location description to a current location of the device.

28. The electronic device according to claim 27, wherein the location description comprises at least one of a tower identification, a network identification, a zip code, an area code and a time zone.

29. A computer program product comprising computer programming instructions for performing the steps of:
receiving a command to enter a low power mode; and
adjusting, in response to receiving the command, at least one operating mode of the device so as to enter a low power operating mode.

30. The computer program product according to claim 29, wherein the adjusting step comprises:
presenting a user with a plurality of operating modes;
accepting an input from the user that indicates a selected operating mode that is chosen from the plurality of operating modes; and
placing the device into the selected operating mode.

31. The computer program product according to claim 29, further comprising computer programming instructions for performing the step of continuing to operate the device after a battery energy level has fallen below a normal operating threshold.

32. The computer program product according to claim 29, further comprising computer programming instructions for performing the steps of:
monitoring an energy level of a battery;
comparing the energy level to a threshold;
transmitting an indication of the energy level to a central controller; and
providing an indication that the indication of the energy level has been transmitted.

33. The computer program product according to claim 29,
wherein the command includes a receiver identification, and
the computer program product further comprises computer programming instructions for performing the step of determining if the receiver identification matches an identification associated with the device.

34. The computer program product according to claim 33,
wherein the receiver identification comprises a location description, and
the determining step comprises comparing the location description to a current location of the device.

35. The computer program product according to claim 34, wherein the location description comprises at least one of a tower identification, a network identification, a zip code, an area code and a time zone.

36. A method for controlling an electronic device, the method comprising the steps of:
receiving at least one of data and voice information from the device; and
transmitting a message to the device, the message including a command to enter a low power mode.
